(19) United States
(12) Patent Application Publication
(10) Pub. No.: US 2026/0195603 A1
(43) Pub. Date: Jul. 9, 2026

(54) METHOD AND ELECTRONIC DEVICE WITH RETRIEVAL MODEL TRAINING

(71) Applicants: Samsung Electronics Co., Ltd., Suwon-si (KR); Korea University Research and Business Foundation, Seoul (KR)

(72) Inventors: Junyeon LEE, Suwon-si (KR); Jaehoon KIM, Seoul (KR); Seoung Bum KIM, Seoul (KR); Byungwoo BANG, Suwon-si (KR); Uiseok SONG, Suwon-si (KR); Jungmin LEE, Seoul (KR); Yongtae JEONG, Seoul (KR); Hansam CHO, Seoul (KR); Changwook CHU, Seoul (KR)

(73) Assignees: Samsung Electronics Co., Ltd., Suwon-si (KR); Korea University Research and Business Foundation, Seoul (KR)

(21) Appl. No.: 19/301,812

(22) Filed: Aug. 15, 2025

(30) Foreign Application Priority Data
Jan. 6, 2025 (KR) 10-2025-0001748
May 15, 2025 (KR) 10-2025-0063398

(51) Int. Cl. G06N 3/0895

(52) U.S. Cl. CPC G06N 3/0895

(57) ABSTRACT

A processor-implemented method with training of a retrieval augmented model includes generating a first embedding representation for a positive sample for a query and a second embedding representation for each of negative samples for the query, the positive sample and the negative samples being samples paired with the query, labeling a value that is within a predetermined range of values and corresponds to a similarity between the first embedding representation for the positive sample and the second embedding representation for each of the negative samples, on a corresponding negative sample, wherein a maximum value of “the predetermined range of values is labeled on the positive sample, and training the retrieval augmented model based on a contrastive loss with respect to the query and the labeled positive sample and the labeled negative samples paired with the query.

### CROSS-REFERENCE TO RELATED APPLICATIONS

This application claims the benefit under 35 USC § 119(a) of Korean Patent Applications No. 10-2025-0001748, filed on Jan. 6, 2025, and No. 10-2025-0063398, filed on May 15, 2025, in the Korean Intellectual Property Office, the entire disclosures of which are incorporated herein by reference for all purposes.

### BACKGROUND

### 1. Field

The following description relates to a method and electronic device with retrieval model training.

### 2. Description of Related Art

A large language model (LLM) is an artificial intelligence (AI) technology that may support an intelligent chatbot and other natural language processing applications, and may generate a result for tasks, such as a response to a user's inquiry, language translation, and sentence completion. Known issues with the LLM may include hallucination providing false answers, generating a response from unreliable sources, and providing outdated or generic information.

Retrieval-augmented generation (RAG) is a process of referring to a reliable external knowledge base of a training data source of the LLM before generating a response. Firstly, relevant documents may be retrieved from external data sources in various formats, such as an application program interface (API), a database, or a document repository, based on a user query using a retrieval model. The LLM may generate a final response taking the retrieved documents as inputs with the user query.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method with training of a retrieval augmented model includes generating a first embedding representation for a positive sample for a query and a second embedding representation for each of negative samples for the query, the positive sample and the negative samples being samples paired with the query, labeling a value that is within a predetermined range of values and corresponds to a similarity between the first embedding representation for the positive sample and the second embedding representation for each of the negative samples, on a corresponding negative sample, wherein a maximum value of “the predetermined range of values is labeled on the positive sample, and training the retrieval augmented model based on a contrastive loss with respect to the query and the labeled positive sample and the labeled negative samples paired with the query.

The training of the retrieval augmented model based on the contrastive loss may include generating embedding representations output by an online encoder of the retrieval augmented model by inputting the query and the labeled positive sample and the labeled negative samples paired with the query to the online encoder, determining the contrastive loss based on a similarity between a query embedding representation for the query and a sample embedding representation for each of the labeled positive sample and the labeled negative samples, and training the online encoder based on the contrastive loss.

The determining of the contrastive loss based on the similarity between the query embedding representation for the query and the sample embedding representation for each of the labeled positive sample and the labeled negative samples may include determining the contrastive loss based on a first similarity between the query embedding representation for the query and a sample embedding representation for the labeled positive sample and a second similarity between the query embedding representation for the query and a sample embedding representation for each of the negative samples.

The training of the retrieval augmented model based on the contrastive loss further may include training a target encoder of the retrieval augmented model through an exponential moving average using a parameter of the trained online encoder.

The method may include generating a training dataset, using the trained target encoder, corresponding to a second batch that is different from a first batch comprising the samples paired with the query among batches generated by sampling a raw dataset, and additionally training the trained online encoder based on the training dataset.

The method may include additionally training the trained target encoder through an exponential moving average using a parameter of the additionally trained online encoder.

The method may include obtaining one or more samples as a retrieval result for a user query from a database using the trained retrieval augmented model, and generating a response to the user query using at least a portion of the one or more samples.

The obtaining of the one or more samples as the retrieval result for the user query from the database using the trained retrieval augmented model may include generating an embedding representation output by an trained online encoder of the trained retrieval augmented model by inputting the user query to the trained online encoder, and obtaining the one or more samples as the retrieval result from the database based on a comparison between the embedding representation for the user query with embedding vectors indexed on samples comprised in the database.

The obtaining of the one or more samples as the retrieval result based on the comparison between the embedding representation for the user query with the embedding vectors indexed on the samples comprised in the database may include determining a score indicating a similarity between the embedding representation for the user query and the embedding representations indexed on the samples comprised in the database, and obtaining, from the database, the one or more samples of which a corresponding score satisfies a determined condition among the samples comprised in the database.

The generating of the first embedding representation for the positive sample and the second embedding representation for each of the negative samples may include generating the first embedding representation for the positive sample and the second embedding representation for each of the negative samples output by a target encoder of the retrieval augmented model by inputting the positive sample and the negative samples to the target encoder.

The values labeled on the negative samples may be values greater than or equal to 0 and less than 1, and the value labeled on the positive sample may be a value of 1.

In one or more general aspects, a processor-implemented method with training of a retrieval augmented model includes generating a first embedding representation for a positive sample for a query and a second embedding representation for each of negative samples for the query output by a target encoder of the retrieval augmented model by inputting the positive sample and the negative samples to the target encoder, the positive sample and the negative samples being samples paired with the query, labeling a value that is within a predetermined range of values and corresponds to a similarity between the first embedding representation for the positive sample and the second embedding representation for each of the negative samples, on a corresponding negative sample, wherein a maximum value of the predetermined range of values is labeled on the positive sample, and training an online encoder of the retrieval augmented model based on a contrastive loss with respect to the query and the labeled positive sample and the labeled negative samples paired with the query.

The training of the online encoder of the retrieval augmented model based on the contrastive loss may include generating embedding representations output by the online encoder of the retrieval augmented model by inputting the query and the labeled positive sample and the labeled negative samples paired with the query to the online encoder, determining the contrastive loss based on a similarity between a query embedding representation for the query and a sample embedding representation for each of the labeled positive sample and the labeled negative samples, and training the online encoder based on the contrastive loss.

The determining of the contrastive loss based on the similarity between the query embedding representation for the query and the sample embedding representation for each of the labeled positive sample and the labeled negative samples may include determining the contrastive loss based on a first similarity between the query embedding representation for the query and a sample embedding representation for the labeled positive sample and a second similarity between the query embedding representation for the query and a sample embedding representation for each of the labeled negative samples.

The method may include training the target encoder of the retrieval augmented model by using an exponential moving average using a parameter of the trained online encoder.

The method may include generating a training dataset, using the trained target encoder, corresponding to a second batch that is different from the first batch comprising the query and the samples paired with the query among batches generated by sampling a raw dataset, additionally training the trained online encoder based on the training dataset, and additionally training the trained target encoder by using an exponential moving average using a parameter of the additionally trained online encoder.

The method may include obtaining one or more samples as a retrieval result for a user query from a database by using an trained retrieval augmented model comprising the trained online encoder, and generating a response to the user query by using at least a portion of the one or more samples.

The obtaining of the one or more samples as the retrieval result for the user query from the database by using the trained retrieval augmented model may include generating an embedding representation output by the trained online encoder of the trained retrieval augmented model by inputting the user query to the trained online encoder, and obtaining the one or more samples as the retrieval result from the database based on a comparison between the embedding representation for the user query and embedding vectors indexed on samples comprised in the database.

The obtaining of the one or more samples as the retrieval result from the database based on the comparison between the embedding representation for the user query and the embedding vectors indexed on the samples comprised in the database may include determining a score indicating a similarity between the embedding representation for the user query and the embedding representations indexed on the samples comprised in the database, and obtaining, from the database, the one or more samples of which respective scores satisfy a determined condition among the samples comprised in the database as the retrieval result.

In one or more general aspects, an electronic device includes one or more processors comprising processing circuitry, and memory comprising one or more storage media storing instructions that, when executed individually or collectively by the one or more processors, cause the electronic device to generate a first embedding representation for a positive sample for a query and a second embedding representation for each of negative samples for the query, the positive sample and the negative samples being samples paired with the query, label a value that is within a predetermined range of values and corresponds to a similarity between the first embedding representation for the positive sample and the second embedding representation for each of the negative samples, on a corresponding negative sample, wherein a maximum value of the predetermined range of values is labeled on the positive sample, and train a retrieval augmented model based on a contrastive loss with respect to the query and the labeled positive sample and the labeled negative samples paired with the query.

Other features and aspects will be apparent from the following detailed description, the drawings, and the claims.

### BRIEF DESCRIPTION OF THE DRAWINGS

FIG. 1 is a schematic diagram of a response system, according to one or more embodiments.

FIG. 2 is a diagram schematically illustrating a method of operating a retrieval model, according to one or more embodiments.

FIG. 3 is a diagram illustrating a sample, according to one or more embodiments.

FIG. 4 is a diagram illustrating training data, according to one or more embodiments.

FIG. 5 is a diagram illustrating a method of training a retrieval model, according to one or more embodiments.

FIG. 6 is a block diagram of an electronic device, according to one or more embodiments.

FIG. 7 is a flowchart of a method of training a retrieval model, according to one or more embodiments.

FIG. 8 is a flowchart of a method of training a retrieval model, according to one or more embodiments.

FIG. 9 is a flowchart of a method of generating a response, according to one or more embodiments.

FIG. 10 is a flowchart of a method of training a retrieval model, according to one or more embodiments.

FIG. 11 is a flowchart of a method of training a retrieval model, according to one or more embodiments.

Throughout the drawings and the detailed description, unless otherwise described or provided, the same drawing reference numerals may be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which the present disclosure pertains and specifically in the context on an understanding of the disclosure of the present application. It will be further understood that terms, such as those defined in commonly-used dictionaries, should be interpreted as having a meaning that is consistent with their meaning in the context of the relevant art and specifically in the context of the disclosure of the present application, and will not be interpreted in an idealized or overly formal sense unless expressly so defined herein.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C” (e.g., each phrase may include any one of the respective items alone, all of the items listed together, and all possible combinations thereof), and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example”, “embodiment”, and “example embodiment” herein have a same meaning (e.g., the phrasing ‘in an or one example’ has a same meaning as ‘in an or one embodiment” and ‘in an or one example embodiment’), and “one or more examples” has a same meaning as “one or more embodiments” and “one or more example embodiments”. Still further, each of multiple or all separately described an/one “example”, “embodiment”, “example embodiment”, as well as “examples”, “embodiments”, “example embodiments”, herein may be included, in combination, in a same embodiment in any combination.

Hereinafter, embodiments will be described in detail with reference to the accompanying drawings. When describing the embodiments with reference to the accompanying drawings, like reference numerals refer to like elements and a repeated description related thereto will be omitted.

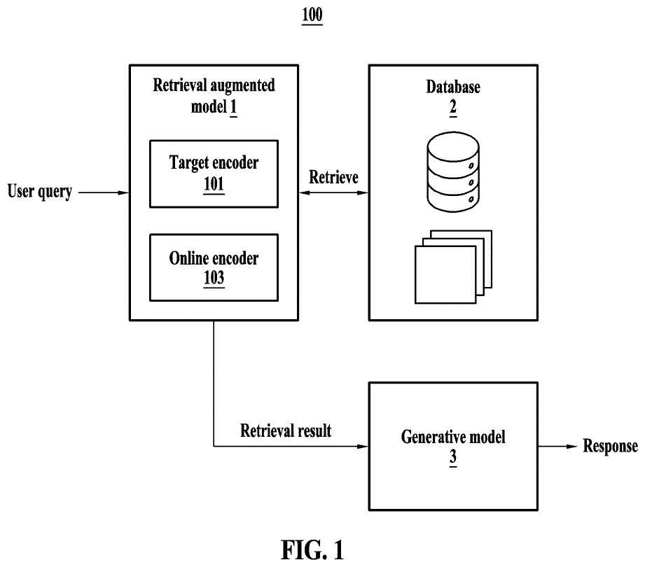

FIG. 1 is a schematic diagram of a response system according to one or more embodiments.

A response system (hereinafter, also referred to as a “system”) 100 in one or more embodiments may be a system for retrieval-augmented generation (RAG). RAG may be a process of referring to a reliable external knowledge base of a training data source of a generative model 3 before the generative model 3 generates a response based on a user input.

The system 100 may include a database 2, a retrieval augmented model 1 for retrieving a relevant document file from the database 2 based on a user query, and the generative model 3 for generating a response to the user query based on a retrieval result of the retrieval augmented model 1.

The generative model 3 may be or include an artificial intelligence (AI) neural network configured to generate new data based on a user input. The generative model 3 may include a language generation model (e.g., a large language model (LLM)) and/or a multimodal generative model (e.g., a large multimodal model (LMM)).

In the system 100, the retrieval augmented model 1 may obtain a user query (e.g., a prompt and/or a natural language query). For example, the system 100 may include a user terminal such as a smartphone, a tablet, a laptop, and/or a personal computer (PC). The retrieval augmented model 1 may receive the user query from the user terminal. In an example, the user terminal may include and implement the retrieval augmented model 1 and the generative model 3.

The user query may also be referred to as an input, a request, and/or a question of the user, and may include, for example, natural language text, an image, a video, audio, and/or a combination thereof. Alternatively, the user query may indicate information generated by preprocessing a request of the user in any data format. For example, in the system 100, the user query may be refined by, for example, removing an unnecessary portion (e.g., an article, a preposition, a special character) from the user's request, tokenizing a sentence into sub-words, extracting a keyword based on importance, and/or reducing the length according to priority.

The retrieval augmented model 1 may retrieve data highly relevant to the user query from the database 2. For example, the retrieval augmented model 1 may obtain text data similar to the user query in text format as a retrieval result from the database 2.

The database 2 may include document data. The document data may correspond to a document file including an image or text or a multi-modal document file including different data types. The data types may include, for example, at least one of a first type (e.g., text), a second type (e.g., an image), a third type (e.g., a table), and/or a fourth type (e.g., a graph). Hereinafter, a non-limiting example of a method of retrieving text as document data related to the user query from the database 2 is described. The retrieved text from the database 2 may be a sample, a passage, and/or a file in the text format.

The generative model 3 may generate a response based on the retrieval result of the retrieval augmented model 1. The generative model 3 may generate the response based on the retrieval result of the retrieval augmented model 1 and the user's request (or the user query).

The retrieval execution ability and/or configuration of the retrieval augmented model 1 and quality of external knowledge (e.g., the database 2) may affect the performance of the response generated by the generative model 3. For example, the retrieval augmented model 1 may be appropriately fine-tuned to generate an effective response in a specialized domain, such as software development, medical, law, and aviation.

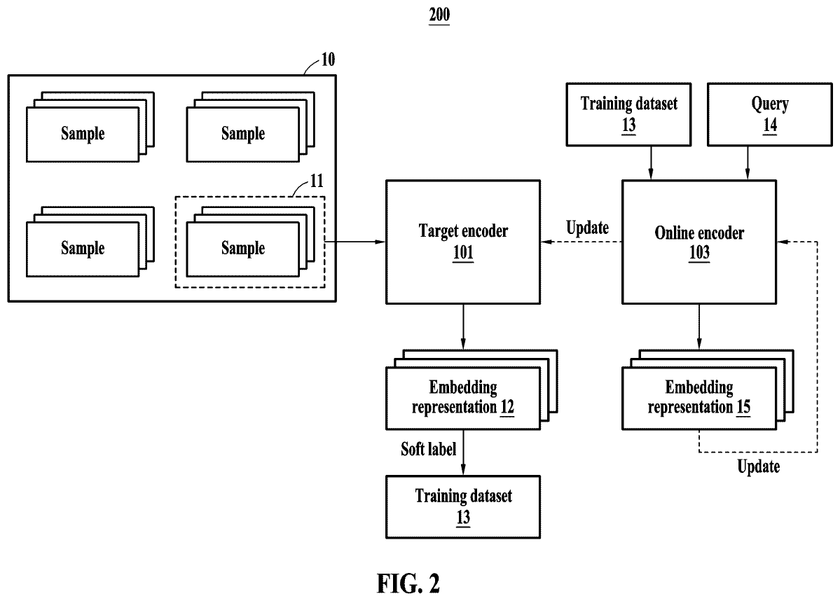

In examples herein, the retrieval augmented model 1 may be trained by contrastive learning. The retrieval augmented model 1 may retrieve data similar to the user query from the database 2 using an online encoder 103 trained by contrastive learning. The retrieval augmented model 1 may generate training data for contrastive learning using a target encoder 101. Hereinafter, an example of a method of operating the retrieval augmented model 1 is described with reference to FIG. 2.

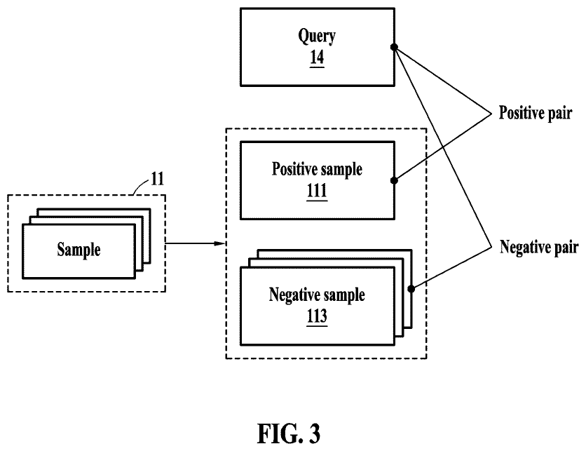

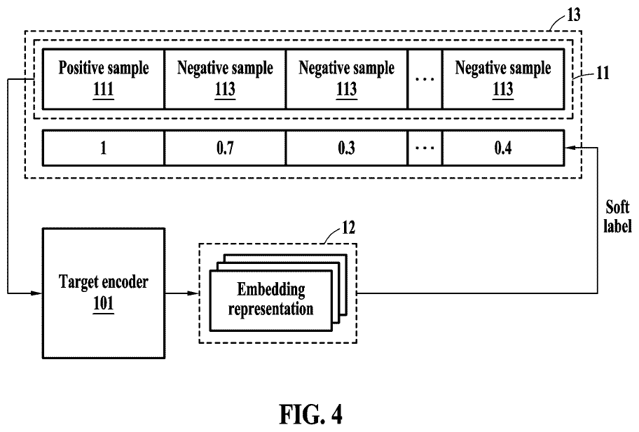

FIG. 2 is a diagram schematically illustrating a method of operating a retrieval model, according to one or more embodiments. FIG. 3 is a diagram illustrating a sample, according to one or more embodiments. FIG. 4 is a diagram illustrating training data, according to one or more embodiments.

A response system (hereinafter, also referred to as a “system”) 200 (e.g., the response system 100 of FIG. 1) of FIG. 2 in one or more embodiments may include the retrieval augmented model 1 of FIG. 1.

The retrieval augmented model 1 may include the target encoder 101 and the online encoder 103. The target encoder 101 and the online encoder 103 may represent language model-based vector encoders.

The target encoder 101 and the online encoder 103 may be trained to extract feature information (e.g., a grammatical structure, a relation between words, semantic information, etc.) by processing input text and may convert the extracted feature information into a high-dimensional embedding representation. The feature information extracted by the target encoder 101 and the online encoder 103 may be used for a task, such as topic classification, sentiment analysis, and summary generation.

The system 200 may obtain a raw dataset 10 including various samples. The system 200 may generate batches (e.g., a batch 11) by sampling the raw dataset 10. Each batch may include samples paired with an arbitrary query. Each batch may include a positive sample and negative samples for an arbitrary query. For example, each batch may include a total of 32 samples including a positive sample and 31 negative samples for an arbitrary query.

Referring to FIG. 3, for example, the batch 11 may include a sample paired with a query 14. The samples paired with the query 14 may include a positive sample 111 and negative samples 113 for the query 14.

The query 14 and the positive sample 111 may form a positive pair. The query 14 and the negative samples 113 may form negative pairs.

Referring back to FIG. 2, the system 200 may generate a training dataset corresponding to each batch using the target encoder 101.

For example, the system 200 may generate embedding representations 12 output by the target encoder 101 by inputting samples of the batch 11 to the target encoder 101. The embedding representations may include a first embedding representation for the positive sample 111 and second embedding representations for the negative samples 113.

The target encoder 101 may generate embedding representations 12 corresponding to samples by performing embedding on the input samples. Embedding may indicate an operation of converting a given input (e.g., a sample) into one or more numbers (e.g., a vector). The embedding representations may correspond to vectors (e.g., embedding vectors) representing samples by numbers, respectively.

The system 200 may generate the first embedding representation output by the target encoder 101 by inputting the positive sample 111 for the query 14 to the target encoder 101. The system 200 may generate the second embedding representations output by the target encoder 101 by inputting the negative samples 113 for the query 14 to the target encoder 101.

The system 200 may generate a training dataset 13 by labeling a similarity between the first embedding representation for the positive sample 111 and each of the second embedding representations for the negative samples 113 on a corresponding negative sample. The similarity may be a cosine similarity. The similarity may be a value determined within a predetermined range of values (e.g., a value between 0 and 1).

Referring to FIG. 4, the positive sample 111 may be a sample with a highest correlation with the query 14 and may be labeled as “1”. The system 200 may label a similarity between the first embedding representation for the positive sample 111 and the second embedding representation for the arbitrary negative sample 113 on the negative sample. This labeling scheme may be referred to as soft labeling. For example, for the soft labeling, the positive sample 111 may be labeled with a value (e.g., a probability value) of 1 and the negative samples 113 may be labeled with values (e.g., probability values) greater than or equal to 0 and less than 1. For example, each probability value may represent a similarity within a range of 0% similarity (e.g., represented by a probability value of 0) to 100% similarity (e.g., represented by a probability value of 1).

The query 14 and each of the samples of the training dataset 13 may form a sample pair. A sample pair formed of the query 14 and the positive sample 111 may be referred to as a “positive sample pair”. In one or more embodiments, the training dataset 13 to update or train the retrieval augmented model 1 may include the sample pairs and may be construed as that the query 14 is paired with each of the samples 111 and 113 labeled with a value between 0 and 1 as an anchor sample.

By labeling similarities within the predetermined range of values (e.g., soft labeling), a method and device of one or more embodiments may more efficiently train the retrieval augmented model 1, the target encoder 101, and/or the online encoder 103 such that the embedding representations 12 and/or embedding representations 15 are more accurately generated by the respective trained models, and such that the response to the user query is more accurately generated by the generative model 3, compared to a typical method and device that assigns a hard label in a dichotomous or binary manner (e.g., 0 or 1) to training data during contrastive learning.

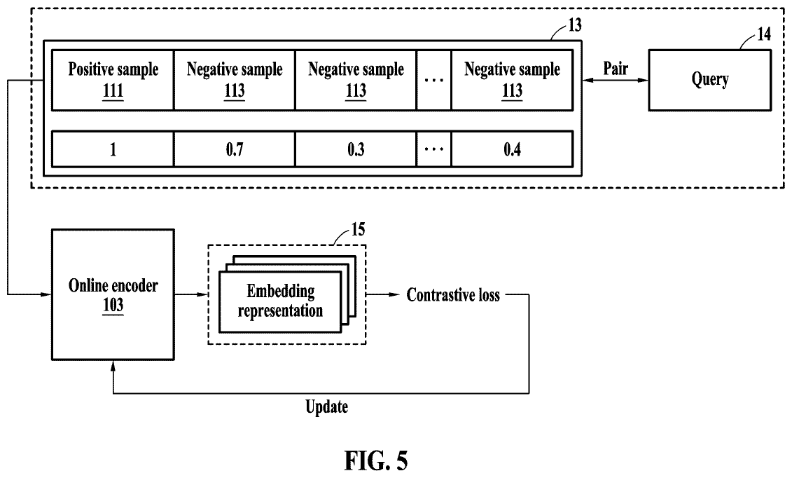

FIG. 5 is a diagram illustrating a method of training a retrieval model, according to one or more embodiments.

Referring to FIGS. 2 to 5, the system 200 may update or train the retrieval augmented model 1 based on the training dataset 13.

The system 200 may update or train the online encoder 103 of the retrieval augmented model by contrastive learning based on the training dataset 13. The system 200 may generate an embedding representation on the query 14 and the samples of the training dataset 13 in real time through the online encoder 103 during the contrastive learning and may continuously update a parameter of the online encoder 103.

The system 200 may generate embedding representations 15 output by the online encoder 103 by inputting the query 14 and the samples of the training dataset 13 to the online encoder 103 of the retrieval augmented model 1. The embedding representations 15 output by the online encoder 103 may include a query embedding representation and sample embedding representations.

The system 200 may generate the query embedding representation output by the online encoder 103 by inputting the query 14 to the online encoder 103 of the retrieval augmented model 1. The system 200 may generate the sample embedding representations output by the online encoder 103 by inputting the samples of the training dataset 13 to the online encoder 103 of the retrieval augmented model 1.

The system 200 may determine a contrastive loss based on a similarity between the query embedding representation for the query 14 and each of the sample embedding representations for the samples. The similarity may be a cosine similarity.

The system 200 may determine the contrastive loss based on a first similarity between the query embedding representation for the query 14 and a sample embedding representation for the positive sample 111 among the samples and a second similarity between the query embedding representation for the query 14 and a sample embedding representation for each of the negative samples 114 among the samples.

The system 200 may update or train the online encoder 103 based on the contrastive loss.

The system 200 may update or train the online encoder 103 (e.g., a parameter of the online encoder) to minimize the contrastive loss. The system 200 may update or train the online encoder 103 to increase the first similarity between the query embedding representation and the sample embedding representation for the positive sample 111. The system 200 may update or train the online encoder 103 to sort the second similarities between the query embedding representation and each of the negative samples 113 according to labeling values of the respective negative samples 113.

Referring to FIG. 2, the system 200 may slowly update or train the target encoder 101 by an exponential moving average (EMA) using the parameter of the online encoder 103 for learning stability.

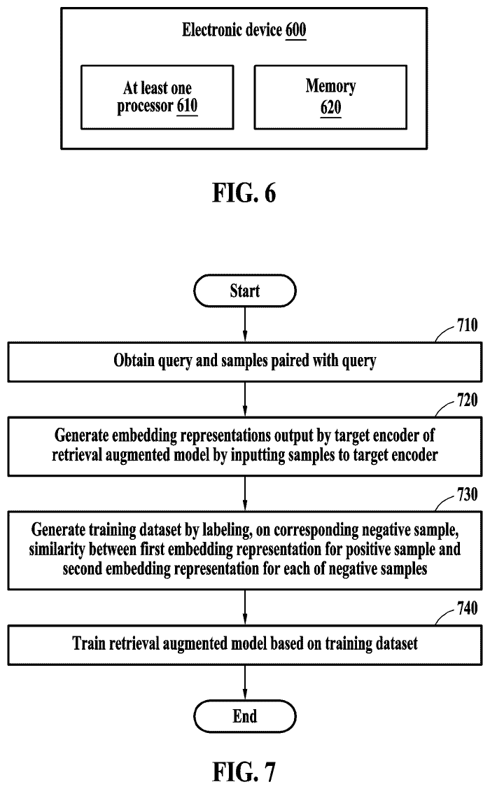

FIG. 6 is a block diagram of an electronic device, according to one or more embodiments.

An electronic device 600 may be various computing devices such as a high performance computer (HPC), a server computer, a desktop, a workstation, and/or a user terminal such as a smartphone, a tablet, a laptop, and/or a personal computer (PC).

An electronic device 600 according to one or more embodiments may include at least one processor (e.g., one or more processors, hereinafter, also referred to as a processor) 610 including processing circuitry and a memory 620 (e.g., one or more memories) including one or more storage media storing instructions. When the instructions are individually or collectively executed by the processor 610, the instructions may cause the electronic device 600 to perform at least a portion of the operations described herein with reference to FIGS. 1 to 9. For example, the memory 620 may be or include a non-transitory computer-readable storage medium storing instructions that, when executed by the processor 610, configure the processor 610 to perform any one, any combination, or all of the operations and/or methods disclosed herein with reference to FIGS. 1-11.

The electronic device 600 may include a communication module connected to the processor 610 and the memory 620 to transmit and receive data. The communication module may be connected to other external devices to transmit and receive data. Hereinafter, the expression “transmit and receive ‘A’” may refer to “transmit and receive ‘information or data indicating A’”.

The communication module may be implemented by circuitry in the electronic device 600. For example, the communication module may include an internal bus and an external bus. For another example, the communication module may be an element to connect the electronic device 600 to an external device. The communication module may be or include an interface, an input/output (I/O) device, a touchscreen (e.g., of a graphical user interface), a mouse, and/or a microphone, as non-limiting examples. The communication module may receive data from an external device and may transmit the data to the processor 610 and the memory 620.

The processor 610 may process data received by the communication module and/or data stored in the memory 620. The “processor” may be a data processing device implemented by hardware including a circuit having a physical structure to perform desired operations. For example, the desired operations may include code or instructions included in a program. For example, the hardware-implemented data processing device may include a microprocessor, a central processing unit (CPU), a graphics processing unit (GPU), a processor core, a multi-core processor, a multiprocessor, an application-specific integrated circuit (ASIC), and a field-programmable gate array (FPGA).

The processor 610 may control other components (e.g., a hardware or software component) of the electronic device 600 and may perform various data processing or computations. As at least a portion of data processing or computation, the processor 610 may store an instruction or data received from another component (e.g., the communication module) in at least a portion of the memory 620, may process the instruction or data stored in the memory 620, and may store resulting data in the memory 620. The operations performed by the processor 610 may be substantially the same as the operations of the electronic device 600.

The memory 620 may store information necessary for the processor 610 to perform a processing operation. The memory 620 (one or more storage media included in the memory 620) may store instructions executed by the processor 610 and may store associated information while executing the software or program in the electronic device 600. For example, the memory 620 may include one or more memories that are volatile and/or non-volatile known in the art, such as random access memory (RAM), dynamic RAM (DRAM), static RAM (SRAM), non-volatile RAM (NVRAM), persistent memory (PMEM), magneto-resistive random memory (MRAM), high bandwidth memory (HBM), and 3DXPoint.

The electronic device 600 may be connected to an external memory via the communication module. For example, the external memory may include at least one volatile memory, non-volatile memory, RAM, flash memory, a hard disk drive, and an optical disk drive. The external memory may store a set of instructions (e.g., software) to operate the electronic device 600. The set of instructions to operate the electronic device 600 may be executed by the processor 610.

In one or more embodiments, the retrieval augmented model 1 described with reference to FIGS. 1 to 5 may be included in the electronic device 600. For example, the retrieval augmented model 1 may be included in a module including processing circuitry in the electronic device 600. For example, a module including the processing circuitry may be operatively coupled to at least one processor (e.g., the processor 610) of the electronic device 600. In an example, the processor 610 may include and/or implement the retrieval augmented model 1, the generative model 3, the target encoder 101, and the online encoder 103 described herein.

In one or more embodiments, the memory 620 may store the retrieval augmented model 1 and/or the database 2. Depending on the implementation, the database 2 may be stored in the memory 620 (or the first memory) and the retrieval augmented model 1 may be stored in another memory (or the second memory).

In one or more embodiments, the electronic device 600 may include a target encoder (e.g., the target encoder 101 of FIGS. 1, 2, and 4) of the retrieval augmented model 1 and an online encoder (e.g., the online encoder 103 of FIGS. 1, 2, and 5). The memory 620 may store the target encoder and the online encoder (e.g., weight parameters of each encoder and related data). The target encoder and the online encoder may be trained to extract feature information by processing input text and convert the extracted feature information into an embedding representation of a high-dimensional space.

The processor 610 may update the database 2. The processor 610 may asynchronously update text (or samples) of the database 2 to maintain latest information. The processor 610 may update an embedding representation indexed on new text.

In one or more embodiments, the database 2 may be implemented as an external data source of the electronic device 600. For example, an external electronic device (e.g., a server or cloud-based document repository) may include the database 2. The electronic device 600 may obtain one or more samples as a retrieval result from the database 2 via communication with the external electronic device including the database 2.

FIG. 7 is a flowchart of a method of training a retrieval model, according to one or more embodiments.

According to one or more embodiments, operations 710 to 740 described below may be performed by an electronic device (e.g., the electronic device 600 of FIG. 6). The electronic device may include at least some of the components of the electronic device 600 described with reference to FIG. 6. For example, the electronic device may include at least one processor (e.g., the at least one processor 610 of FIG. 6) including processing circuitry. The electronic device may include a memory (e.g., the memory 620 of FIG. 6) including one or more storage media storing instructions. The electronic device may include a pre-trained retrieval augmented model (e.g., the retrieval augmented model 1 of FIG. 1). Operations 710 to 740 of FIG. 7 may be performed in the sequence and manner as illustrated in FIG. 7. However, one or more of the operations may be performed in a different order, one or more of the operations may be omitted, two or more of the operations may be performed in parallel or simultaneously, and/or other operations may be additionally performed without departing from the spirit and scope of the described embodiments.

In operation 710, the electronic device may obtain a query and samples paired with the query. The samples may include a positive sample and negative samples for the query.

Prior to or included in operation 710, the electronic device may obtain a raw dataset including various samples. The electronic device may generate batches by sampling the raw dataset. Each batch may include samples paired with an arbitrary query. Each batch may include a positive sample and negative samples for an arbitrary query. For example, each batch may include a total of 32 samples including a positive sample and 31 negative samples for an arbitrary query. Operations 710 to 730 may be construed as an operation of generating a training dataset corresponding to an arbitrary batch (e.g., the first batch) among the batches.

In operation 720, the electronic device may generate embedding representations output by a target encoder by inputting the samples paired with the query to the target encoder of the retrieval augmented model. The embedding representations may include a first embedding representation for the positive sample and second embedding representations for the negative samples.

The target encoder may generate embedding representations corresponding to the samples by performing embedding on the input samples. Embedding may indicate an operation of converting a given input (e.g., a sample) into one or more numbers (e.g., a vector). The embedding representations may correspond to vectors (e.g., embedding vectors) representing samples by numbers, respectively.

The electronic device may generate the first embedding representation output by the target encoder by inputting the positive sample for the query to the target encoder of the retrieval augmented model. The electronic device may generate the second embedding representations output by the target encoder by inputting the negative samples for the query to the target encoder of the retrieval augmented model. For example, the electronic device may generate the second embedding representation for each of the negative samples.

In operation 730, the electronic device may generate a training dataset by labeling, on the corresponding negative sample, a similarity between the first embedding representation for the positive sample among the samples and the second embedding representation for each of the negative samples among the samples. The similarity may be a cosine similarity. The similarity may be a value between 0 and 1.

The positive sample may be a sample with a highest correlation with the query and may be labeled as “1”. The electronic device may label a similarity between the first embedding representation and a second embedding representation for an arbitrary negative sample on the negative sample. This labeling scheme may be referred to as soft labeling.

In operation 740, the electronic device may train the retrieval augmented model based on the training dataset.

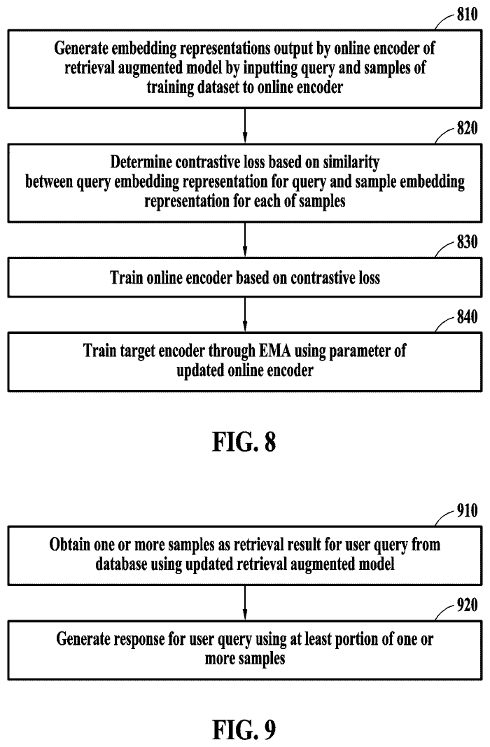

In operation 740, the electronic device may update or train an online encoder (e.g., the online encoder 103 of FIGS. 1, 2, and 5) by contrastive learning based on the training dataset. The electronic device may generate an embedding representation on the query and the samples of the training dataset in real time through the online encoder during the contrastive learning and may continuously update a parameter of the online encoder. The electronic device may slowly update or train the target encoder described above through an EMA using the parameter of the online encoder for learning stability. An example of a method of updating the retrieval augmented model is further described with reference to FIG. 8.

According to one or more embodiments, in operations 710 to 740 described above, the electronic device may update or train the retrieval augmented model based on the training dataset corresponding to an arbitrary batch of the batches. For example, in operations 710 to 730, the electronic device may generate a first training dataset corresponding to the first batch of the batches. In operation 740, the electronic device may update or train the retrieval augmented model based on the first training dataset. For example, the electronic device may update or train the online encoder of the retrieval augmented model based on the first training dataset. The electronic device may update or train the target encoder through the EMA using the parameter of the online encoder updated or trained based on the first training dataset.

The electronic device may iteratively perform operations 710 to 740 on each of the batches. For example, the electronic device may obtain a second batch that is different from the first batch from the batches. The second batch may include samples paired with a query that is different from the query of the first batch. The electronic device may generate embedding representations output by a target encoder updated or trained based on the first training dataset (e.g., a target encoder updated or trained by the EMA using the parameter of the online encoder updated or trained based on the first training dataset) by inputting the samples of the second batch to the target encoder. The electronic device may generate a second training dataset corresponding to the second batch by labeling, on the corresponding negative sample, a similarity between a first embedding representation for a positive sample of the samples of the second batch and a second embedding representation for each of negative samples of the samples of the second batch. The electronic device may update or train the retrieval augmented model based on the second training dataset. For example, the electronic device may additionally update or train the online encoder that is updated or trained based on the first training dataset, based on the second training dataset. The electronic device may additionally update or train the target encoder that is updated or trained based on the first training dataset through the EMA using the parameter of the additionally updated or trained online encoder.

FIG. 8 is a flowchart of a method of training a retrieval model, according to one or more embodiments.

According to one or more embodiments, operations 810 to 840 described below may be performed by an electronic device (e.g., the electronic device 600 of FIG. 6). The electronic device may include at least some of the components of the electronic device 600 described with reference to FIG. 6. For example, the electronic device may include at least one processor (e.g., the at least one processor 610 of FIG. 6) including processing circuitry. The electronic device may include a memory (e.g., the memory 620 of FIG. 6) including one or more storage media storing instructions. The electronic device may include a pre-trained retrieval augmented model (e.g., the retrieval augmented model 1 of FIG. 1). Operations 810 to 840 of FIG. 8 may be performed in the sequence and manner as illustrated in FIG. 8. However, one or more of the operations may be performed in a different order, one or more of the operations may be omitted, two or more of the operations may be performed in parallel or simultaneously, and/or other operations may be additionally performed without departing from the spirit and scope of the described embodiments.

According to one or more embodiments, operation 740 of updating the retrieval augmented model of FIG. 7 may include operations 810 to 840.

In operation 810, the electronic device may generate embedding representations output by an online encoder of the retrieval augmented model by inputting a query and samples of a training dataset (e.g., the training dataset generated in operation 730 of FIG. 7) to the online encoder. The embedding representations output by the online encoder may include a query embedding representation and sample embedding representations.

The electronic device may generate the query embedding representation output by the online encoder by inputting the query to the online encoder of the retrieval augmented model. The electronic device may generate the sample embedding representations output by the online encoder by inputting samples of the training dataset to the online encoder of the retrieval augmented model. For example, the electronic device may generate a sample embedding representation for each of the samples of the training dataset.

In operation 820, the electronic device may determine a contrastive loss based on a similarity between the query embedding representation for the query and the sample embedding representation for each of the samples. The similarity may be a cosine similarity.

The electronic device may determine the contrastive loss based on a first similarity between the query embedding representation for the query and a sample embedding representation for a positive sample among the samples and a second similarity between the query embedding representation for the query and a sample embedding representation for each of negative samples among the samples.

In operation 830, the electronic device may train the online encoder based on the contrastive loss.

The electronic device may update or train the online encoder (e.g., a parameter of the online encoder) to minimize the contrastive loss. The electronic device may update or train the online encoder to increase the first similarity between the query embedding representation and the sample embedding representation for the positive sample. The electronic device may update or train the online encoder to sort the second similarity between the query embedding representation and the sample embedding representation for each of the negative samples according to a labeling value of each negative sample.

In operation 840, the electronic device may train a target encoder (e.g., a parameter of the target encoder) through an EMA using the parameter of the trained online encoder.

FIG. 9 is a flowchart of a method of generating a response, according to one or more embodiments.

According to one or more embodiments, operations 910 and 920 described below may be performed by an electronic device (e.g., the electronic device 600 of FIG. 6). The electronic device may include at least some of the components of the electronic device 600 described with reference to FIG. 6. For example, the electronic device may include at least one processor (e.g., the at least one processor 610 of FIG. 6) including processing circuitry. The electronic device may include a memory (e.g., the memory 620 of FIG. 6) including one or more storage media storing instructions. The electronic device may include a pre-trained retrieval augmented model (e.g., the retrieval augmented model 1 of FIG. 1). Operations 910 and 920 of FIG. 9 may be performed in the sequence and manner as illustrated in FIG. 9. However, one or more of the operations may be performed in a different order, one or more of the operations may be omitted, two or more of the operations may be performed in parallel or simultaneously, and/or other operations may be additionally performed without departing from the spirit and scope of the described embodiments.

According to one or more embodiments, operations 910 and 920 may be performed in response to the retrieval augmented model being updated or trained in operation 740 of FIG. 7.

In one or more embodiments, operations 910 and 920 may be performed on a plurality of batches after operations 710 to 740 are iteratively performed.

In operation 910, the electronic device may obtain one or more samples as a retrieval result for a user query from a database (e.g., the database 2 of FIG. 1) using an updated or trained retrieval augmented model (e.g., the retrieval augmented model updated or trained in operation 740 of FIG. 7).

The electronic device may generate an embedding representation output by an updated or trained online encoder (e.g., the online encoder updated or trained in operation 740 of FIG. 7) by inputting the user query to the updated or trained online encoder.

The electronic device may obtain the one or more samples as a retrieval result from the database based on a comparison between an embedding representation for the user query with embedding representations indexed on samples included in the database.

The electronic device may determine a score indicating a similarity (or relevance) between the embedding representation for the user query and the embedding representations indexed on the samples included in the database. For example, the electronic device may determine a cosine similarity between the embedding representation for the user query and the embedding representations indexed on the samples included in the database to be the score. For example, the electronic device may determine the score based on a Euclidean distance between the embedding representation for the user query and the embedding representations indexed on the samples included in the database. The electronic device may determine the Euclidean distance to be the score or may determine the reverse of the Euclidean distance or a normalized value of the Euclidean distance for the samples to be the score.

The electronic device may obtain, from the database, one or more samples of which a corresponding score satisfies a determined condition among the samples included in the database as a retrieval result. For example, the electronic device may obtain one or more samples of which a corresponding score is greater than or equal to (or exceeds) a threshold value among the samples included in the database as a retrieval result. For example, the electronic device may obtain a determined number of samples of which a corresponding score is greater than or equal to (or exceeds) a threshold value among the samples included in the database as a retrieval result.

However, the example described above may apply to a case in which the score is proportional to the similarity between the embedding representation for the user query and the embedding representations indexed on the samples included in the database (e.g., when the score is a cosine similarity, the reverse of a Euclidean distance, and/or a normalized value of the Euclidean distance). When the score is inversely proportional to the similarity between the embedding representation for the user query and the embedding representations indexed on the samples included in the database (e.g., when the score is a Euclidean distance), the electronic device may obtain one or more samples of which a corresponding score is less than (or less than or equal to) a threshold value among the samples included in the database as a retrieval result.

In operation 920, the electronic device may generate a response to the user query using at least a portion of the one or more samples obtained from the database. The electronic device may output the response to the user query.

In one or more embodiments, the electronic device may generate a response output by a generative model (e.g., the generative model 3 of FIG. 1) by inputting the user query and at least a portion of the one or more samples obtained from the database to the generative model. For example, the electronic device may generate a prompt including the user query and at least a portion of the one or more samples as the contextual information for the user query. The prompt may include an instruction or a command to generate a response based on the user query and at least a portion of the one or more samples. The electronic device may generate a response output by the generative model by inputting the prompt to the generative model. The electronic device may output the response output by the generative model as a response to the user query.

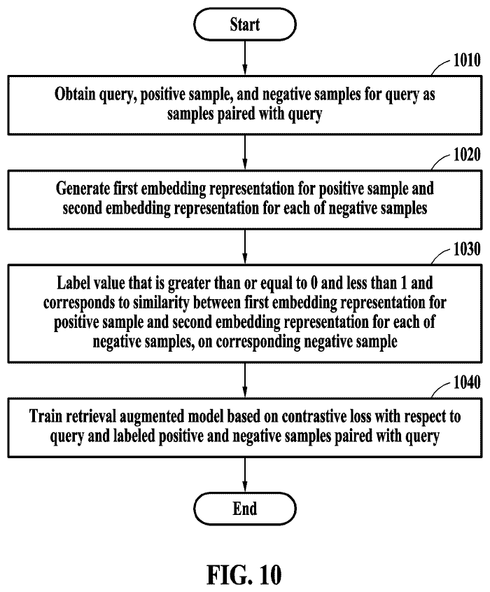

FIG. 10 is a flowchart of a method of training a retrieval model, according to one or more embodiments.

According to one or more embodiments, operations 1010 to 1040 described below may be performed by an electronic device (e.g., the electronic device 600 of FIG. 6). The electronic device may include at least some of the components of the electronic device 600 described with reference to FIG. 6. For example, the electronic device may include at least one processor (e.g., the at least one processor 610 of FIG. 6) including processing circuitry. The electronic device may include a memory (e.g., the memory 620 of FIG. 6) storing one or more storage media storing instructions. The electronic device may include a pre-trained retrieval augmented model (e.g., the retrieval augmented model 1 of FIG. 1). Operations 1010 to 1040 of FIG. 10 may be performed in the sequence and manner as illustrated in FIG. 10. However, one or more of the operations may be performed in a different order, one or more of the operations may be omitted, two or more of the operations may be performed in parallel or simultaneously, and/or other operations may be additionally performed without departing from the spirit and scope of the described embodiments.

In operation 1010, the electronic device may obtain a query and a positive sample and a negative sample for the query as samples paired with the query. For example, the samples paired with the query may include a positive sample and negative samples for the query.

Prior to or included in operation 1010, the electronic device may obtain raw datasets including various samples. The electronic device may generate batches by sampling the raw dataset. Each batch may include samples paired with a query. Each batch may include a positive sample and negative samples for the query. For example, each batch may include a total of 32 samples including one positive sample and 31 negative samples for the query. Operations 1010 to 1030 may be construed as an operation of generating a training dataset corresponding to an arbitrary batch (e.g., the first batch) of the batches.

In operation 1020, the electronic device may generate a first embedding representation for the positive sample and second embedding representations for the respective negative samples.

The electronic device may generate the first embedding representation for the positive sample and the second embedding representations for the respective negative samples output by a target encoder of the retrieval augmented model by inputting the positive sample and the negative samples to the target encoder.

The target encoder may generate embedding representations corresponding to the samples by performing embedding on the input samples. The embedding may indicate an operation of converting a given input (e.g., a sample) into one or more numbers (e.g., a vector). The embedding representations may correspond to vectors (or embedding vectors) representing the samples as numbers, respectively.

In operation 1030, the electronic device may label a value at various scales corresponding to a similarity between the first embedding representation for the positive sample and each of the second embedding representations for the negative samples, on the corresponding negative sample. For example, the electronic device may label a distance (e.g., a Euclidean distance) value corresponding to a similarity between the first embedding representation for the positive sample and each of the second embedding representations for the negative samples, on the corresponding negative sample. In this case, the value of “0” may be labeled on the positive sample.

The value labeled on the negative sample may be greater than or equal to (or exceed) 0, and for example, a non-limited value, a percentage value less than 100, and/or a normalized value less than 1 (e.g., a probability value) may be labeled (e.g., soft labeling) on the negative sample, and the example is not limited thereto. The electronic device may label any value indicating the similarity between the positive sample and the negative sample, on the negative sample.

Operation 1030 may be construed as an operation of generating a training dataset. For example, the training dataset may include a positive sample on which a value of 1 is labeled and negative samples on which values greater than or equal to 0 and less than 1 (e.g., probability values) are respectively labeled.

In operation 1040, the electronic device may train the retrieval augmented model based on a contrastive loss with respect to the query and the labeled positive sample and the labeled negative samples paired with the query.

Operation 1040 may be construed as an operation of updating the retrieval augmented model based on the training dataset. The electronic device may update or train an online encoder (e.g., the online encoder 103 of FIGS. 1, 2, and 5) of the retrieval augmented model by contrastive learning based on the training dataset. The electronic device may generate a query and embedding representations for the samples of the training dataset in real-time by using the online encoder during the contrastive learning and may continuously update or train a parameter of the online encoder. The electronic device may slowly update or train the target encoder described above by an EMA using the parameter of the online encoder for the learning stability.

The electronic device may generate embedding representations output by the online encoder by inputting the query and the labeled positive sample and the labeled negative samples paired with the query to the online encoder of the retrieval augmented model. The embedding representations output by the online encoder may include a query embedding representation for the query and sample embedding representations for the respective samples.

The electronic device may determine the contrastive loss based on a similarity between the query embedding representation for the query and each of the sample embedding representation for the labeled positive sample and the labeled negative samples. For example, the electronic device may determine the contrastive loss based on a cosine similarity between the query embedding representation for the query and each of the sample embedding representations for the labeled positive sample and the labeled negative samples.

The electronic device may determine the contrastive loss based on a first similarity between the query embedding representation for the query and the sample embedding representation for the labeled positive sample and a second similarity between the query embedding representation for the query and each of the sample embedding representations for the labeled negative samples.

The electronic device may update or train the online encoder based on the contrastive loss. The electronic device may update or train the online encoder (e.g., the parameter of the online encoder) to minimize the contrastive loss. The electronic device may update or train the online encoder to increase the first similarity between the query embedding representation and the sample embedding representation for the positive sample. The electronic device may update or train the online encoder to align the second similarities between the query embedding representation and the respective sample embedding representations for the negative samples according to labeled values of the respective negative samples.

The electronic device may update or train the target encoder (e.g., the parameter of the target encoder) of the retrieval augmented model through an EMA using the parameter of the updated or trained online encoder.

Operations 1010 to 1040 may be construed as a process of updating the retrieval augmented model by using the first training dataset corresponding to the first batch of batches generated by sampling the raw dataset. For example, the electronic device may update or train the online encoder of the retrieval augmented model based on the first training dataset. The electronic device may update or train the target encoder through the EMA using the parameter of the updated or trained online encoder based on the first training dataset.

The electronic device may iteratively perform operations 1010 to 1040 on each of the batches.

For example, the electronic device may generate a training dataset corresponding to a second batch that is different from the first batch including the samples paired with the query, among the batches generated by sampling the raw dataset. For example, the electronic device may generate a second training dataset corresponding to the second batch.

The electronic device may generate embedding representations output by a target encoder that is updated or trained based on the first training dataset by inputting the samples of the second batch to the target encoder. The electronic device may generate the second training dataset corresponding to the second batch by labeling a value that is greater than or equal to 0 and less than 1 and corresponds to a similarity between a first embedding representation for a positive sample of the samples of the second batch and each of second embedding representations for negative samples of the samples of the second batch, on the corresponding negative sample.

The electronic device may update or train the retrieval augmented model based on the second training dataset. For example, the electronic device may additionally update or train the online encoder that is updated or trained based on the first training dataset, based on the second training dataset. The electronic device may additionally update or train the target encoder that is updated or trained based on the first training dataset, through the EMA using the parameter of the additionally updated or trained online encoder.

The electronic device may update or train the retrieval augmented model by using another batch in addition to the first batch and the second batch, and the example is not limited thereto.

The electronic device may obtain one or more samples as a retrieval result for a user query from a database (e.g., the database 2 of FIG. 1) by using the updated or trained retrieval augmented model.

The electronic device may generate an embedding representation output by the updated or trained online encoder by inputting the user query to the updated or trained online encoder of the updated or trained retrieval augmented model. The electronic device may obtain the one or more samples as the retrieval result based on a comparison between the embedding representation for the user query and embedding vectors indexed on samples included in the database.

For example, the electronic device may determine a score indicating a similarity (or relevance) between the embedding representation for the user query and the embedding representations indexed on the samples included in the database. For example, the electronic device may determine a cosine similarity between the embedding representation for the user query and the embedding representations indexed on the samples included in the database to be the score. For example, the electronic device may determine the score based on a Euclidean distance between the embedding representation for the user query and the embedding representations indexed on the samples included in the database. The electronic device may determine the Euclidean distance to be the score or may determine the reverse of the Euclidean distance or a normalized value of the Euclidean distances for the samples to be the score.

As a retrieval result, among the samples included in the database, the electronic device may obtain one or more samples of which corresponding scores satisfy a determined condition from the database. For example, among the samples included in the database, the electronic device may obtain one or more samples of which corresponding scores are greater than or equal to (or exceed) a threshold as the retrieval result. For example, among the samples included in the database, the electronic device may obtain a determined number of samples of which corresponding scores are greater than or equal to (or exceed) the threshold as the retrieval result.

However, the example described above may apply to a case (e.g., when the score is the cosine similarity, the reverse of the Euclidean distance, and/or the normalized value of the Euclidean distance) in which the score is proportional to the similarity between the embedding representation for the user query and the embedding representations indexed on the samples included in the database. When the score is inversely proportional to the similarity between the embedding representation for the user query and the embedding representations indexed on the samples included in the database (e.g., when the score is the Euclidean distance), among the samples included in the database, the electronic device may obtain one or more samples of which corresponding scores are less than (or less than or equal to) the threshold as the retrieval result.

The electronic device may generate a response to the user query by using at least a portion of the one or more samples. The electronic device may output the response to the user query.

In one or more embodiments, the electronic device may generate a response output by a generative model (e.g., the generative model 3 of FIG. 1) by inputting the user query and at least a portion of the one or more samples obtained from the database to the generative model. For example, the electronic device may generate a prompt including a user query and at least a portion of the one or more samples as contextual information with respect to the user query. The prompt may include an instruction or command to generate a response based on the user query and at least a portion of the one or more samples. The electronic device may generate a response output by the generative model by inputting the prompt to the generative model. The electronic device may output the output response as the response to the user query.

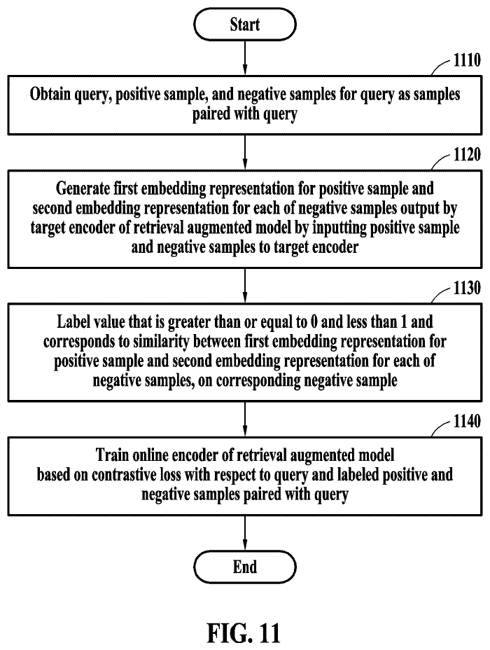

FIG. 11 is a flowchart of a method of training a retrieval model, according to one or more embodiments.

According to one or more embodiments, operations 1110 to 1140 described below may be performed by an electronic device (e.g., the electronic device 600 of FIG. 6). The electronic device may include at least some of the components of the electronic device 600 described with reference to FIG. 6. For example, the electronic device may include at least one processor (e.g., the at least one processor 610 of FIG. 6) including processing circuitry. The electronic device may include a memory (e.g., the memory 620 of FIG. 6) including one or more storage media storing instructions. The electronic device may include a pre-trained retrieval augmented model (e.g., the retrieval augmented model 1 of FIG. 1). Operations 1110 and 1140 of FIG. 11 may be performed in the sequence and manner as illustrated in FIG. 11. However, one or more of the operations may be performed in a different order, one or more of the operations may be omitted, two or more of the operations may be performed in parallel or simultaneously, and/or other operations may be additionally performed without departing from the spirit and scope of the described embodiments.

In operation 1110, the electronic device may obtain a query and a positive sample and negative samples for the query as samples paired with the query.

Prior to operation 1110, the electronic device may obtain a raw dataset including various samples. The electronic device may generate batches by sampling the raw dataset. Each batch may include a query and samples paired with the query. Each batch may include a positive sample and negative samples for the query. For example, each batch may include a total of 32 samples including one positive sample and 31 negative samples for the query. Operations 1110 to 1130 may be construed as an operation of generating a training dataset corresponding to an arbitrary batch (e.g., the first batch) among the batches.

In operation 1120, the electronic device may generate a first embedding representation for the positive sample and second embedding representations for the respective negative samples output by a target encoder of the retrieval augmented model by inputting the positive sample and the negative samples to the target encoder.

The target encoder may generate embedding representations corresponding to the samples by performing embedding on the input samples. The embedding may indicate an operation of converting a given input (e.g., a sample) into one or more numbers (e.g., a vector). The embedding representations may correspond to vectors (or embedding vectors) representing the samples as numbers, respectively.

In operation 1130, the electronic device may label a value that is greater than or equal to 0 and less than 1 corresponding to a similarity between the first embedding representation for the positive sample and the second embedding representation for each of the negative samples, on the corresponding negative sample. For example, the similarity labeled on the negative sample may be a cosine similarity.

The positive sample may be a sample that is the most relevant to the query, and a value of “1” may be labeled on the positive sample. For example, the electronic device may label a value of “1” on the positive sample. For example, the electronic device may obtain the positive sample on which a value of “1” is labeled.

Operation 1130 may be construed as an operation of generating a training dataset. For example, the training dataset may include a positive sample on which a value of “1” is labeled and negative samples on which values greater than or equal to 0 and less than 1 are labeled, respectively.

In operation 1140, the electronic device may train an online encoder of the retrieval augmented model based on a contrastive loss with respect to the query and the labeled positive sample and the labeled negative samples paired with the query.

Operation 1140 may be construed as an operation of updating the retrieval augmented model based on the training dataset. The electronic device may update or train an online encoder (e.g., the online encoder 103 of FIGS. 1, 2, and 5) of the retrieval augmented model by contrastive learning based on the training dataset. The electronic device may generate a query and embedding representations for the samples of the training dataset in real-time through the online encoder during the contrastive learning and may continuously update or train a parameter of the online encoder. The electronic device may slowly update or train the target encoder described above by using an EMA using the parameter of the online encoder for the learning stability.

The electronic device may generate embedding representations output by the online encoder by inputting the query and the labeled positive and negative samples paired with the query to the online encoder of the retrieval augmented model. The embedding representations output by the online encoder may include a query embedding representation for the query and sample embedding representations for the respective samples.

The electronic device may determine a contrastive loss based on a similarity between the query embedding representation for the query and each of the sample embedding representations for the labeled positive and negative samples. For example, the electronic device may determine the contrastive loss based on a cosine similarity between the query embedding representation for the query and each of the sample embedding representations for the labeled positive and negative samples.

The electronic device may determine the contrastive loss based on a first similarity between the query embedding representation for the query and the sample embedding representation for the labeled positive sample and a second similarity between the query embedding representation for the query and each of the sample embedding representations for the labeled negative sample.

The electronic device may update or train an online encoder based on the contrastive loss. The electronic device may update or train the online encoder (e.g., a parameter of the online encoder) to minimize the contrastive loss. The electronic device may update or train the online encoder to increase the first similarity between the query embedding representation and the sample embedding representation for the positive sample. The electronic device may update or train the online encoder to align the second similarities between the query embedding representation and the respective sample embedding representations for the negative samples according to labeled values of the respective negative samples.

The electronic device may update or train the target encoder (e.g., a parameter of the target encoder) of the retrieval augmented model by using an EMA using the parameter of the updated or trained online encoder.

Operations 1110 to 1140 may be construed as a process of updating the retrieval augmented model by using the first training dataset corresponding to the first batch of the batches generated by sampling the raw dataset. For example, the electronic device may update or train the online encoder of the retrieval augmented model based on the first training dataset. The electronic device may update or train the target encoder by using the EMA using the parameter of the online encoder that is updated or trained based on the first training dataset.

The electronic device may iteratively perform operations 1110 to 1140 on each of the batches.

Among the batches generated by sampling the raw dataset, the electronic device may generate a training dataset corresponding to a second batch that is different from the first batch including the query and the samples paired with the query described above, by using the updated or trained target encoder. The second batch may include samples paired with a query that is different from the query of the first batch. For example, the electronic device may generate a second training dataset corresponding to the second batch.

The electronic device may generate embedding representations output by a target encoder that is updated or trained based on the first training dataset by inputting the samples of the second batch to the target encoder. The electronic device may generate the second training dataset corresponding to the second batch by labeling a value that is greater than or equal to 0 and less than 1 and corresponds to a similarity between a first embedding representation for a positive sample of the samples of the second batch and each of second embedding representations for negative samples of the samples of the second batch, on the corresponding negative sample.

The electronic device may update or train the retrieval augmented model based on the second training dataset. For example, the electronic device may additionally update or train the online encoder that is updated or trained based on the first training dataset, based on the second training dataset. The electronic device may additionally update or train the target encoder that is updated or trained based on the first training dataset by using an EMA using the parameter of the additionally updated or trained online encoder.

The electronic device may update or train the retrieval augmented model by using a batch other than the first and second batches, and the example is not limited thereto.

The electronic device may obtain one or more samples as a retrieval result for the user query from a database (e.g., the database 2 of FIG. 1) by using the updated or trained retrieval augmented model including the updated or trained online encoder.

The electronic device may generate an embedding representation output by the updated or trained online encoder of the updated or trained retrieval augmented model by inputting the user query to the updated or trained online encoder. The electronic device may obtain the one or more samples as the retrieval result from the database based on a comparison between the embedding representation for the user query and the embedding representations indexed on the samples included in the database.

The electronic device may determine a score indicating a similarity (or relevance) between the embedding representation for the user query and the embedding representations indexed on the samples included in the database. The electronic device may obtain one or more samples of which corresponding scores satisfy a determined condition among the samples included in the database, as the retrieval result from the database. For example, the electronic device may obtain one or more samples of which corresponding scores are greater than or equal to (or exceed) a threshold among the samples included in the database, as the retrieval result. For example, the electronic device may obtain a determined number of samples of which corresponding scores are greater than or equal to (or exceed) the threshold among the samples included in the database, as the retrieval result.

The electronic device may generate a response to the user query by using at least a portion of the one or more samples. A repeated description of the descriptions provided above with reference to FIGS. 1 to 10 is omitted.

The systems, target encoders, online encoders, electronic devices, processors, memories, system 100, target encoder 101, online encoder 103, system 200, electronic device 600, processor 610, and memory 620 described herein, including descriptions with respect to respect to FIGS. 1-11, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-11 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD−Rs, CD+Rs, CD−RWs, CD+RWs, DVD-ROMs, DVD−Rs, DVD+Rs, DVD−RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method with training of a retrieval augmented model, the method comprising:
generating a first embedding representation for a positive sample for a query and a second embedding representation for each of negative samples for the query, the positive sample and the negative samples being samples paired with the query;
labeling a value that is within a predetermined range of values and corresponds to a similarity between the first embedding representation for the positive sample and the second embedding representation for each of the negative samples, on a corresponding negative sample, wherein a maximum value of “the predetermined range of values is labeled on the positive sample; and
training the retrieval augmented model based on a contrastive loss with respect to the query and the labeled positive sample and the labeled negative samples paired with the query.

2. The method of claim 1, wherein the training of the retrieval augmented model based on the contrastive loss comprises:
generating embedding representations output by an online encoder of the retrieval augmented model by inputting the query and the labeled positive sample and the labeled negative samples paired with the query to the online encoder;
determining the contrastive loss based on a similarity between a query embedding representation for the query and a sample embedding representation for each of the labeled positive sample and the labeled negative samples; and
training the online encoder based on the contrastive loss.

3. The method of claim 2, wherein the determining of the contrastive loss based on the similarity between the query embedding representation for the query and the sample embedding representation for each of the labeled positive sample and the labeled negative samples comprises determining the contrastive loss based on a first similarity between the query embedding representation for the query and a sample embedding representation for the labeled positive sample and a second similarity between the query embedding representation for the query and a sample embedding representation for each of the negative samples.

4. The method of claim 2, wherein the training of the retrieval augmented model based on the contrastive loss further comprises training a target encoder of the retrieval augmented model through an exponential moving average using a parameter of the trained online encoder.

5. The method of claim 4, further comprising:
generating a training dataset, using the trained target encoder, corresponding to a second batch that is different from a first batch comprising the samples paired with the query among batches generated by sampling a raw dataset; and
additionally training the trained online encoder based on the training dataset.

6. The method of claim 5, further comprising additionally training the trained target encoder through an exponential moving average using a parameter of the additionally trained online encoder.

7. The method of claim 1, further comprising:
obtaining one or more samples as a retrieval result for a user query from a database using the trained retrieval augmented model; and
generating a response to the user query using at least a portion of the one or more samples.

8. The method of claim 7, wherein the obtaining of the one or more samples as the retrieval result for the user query from the database using the trained retrieval augmented model comprises:
generating an embedding representation output by an trained online encoder of the trained retrieval augmented model by inputting the user query to the trained online encoder; and
obtaining the one or more samples as the retrieval result from the database based on a comparison between the embedding representation for the user query with embedding vectors indexed on samples comprised in the database.

9. The method of claim 8, wherein the obtaining of the one or more samples as the retrieval result based on the comparison between the embedding representation for the user query with the embedding vectors indexed on the samples comprised in the database comprises:
determining a score indicating a similarity between the embedding representation for the user query and the embedding representations indexed on the samples comprised in the database; and
obtaining, from the database, the one or more samples of which a corresponding score satisfies a determined condition among the samples comprised in the database.

10. The method of claim 1, wherein the generating of the first embedding representation for the positive sample and the second embedding representation for each of the negative samples comprises generating the first embedding representation for the positive sample and the second embedding representation for each of the negative samples output by a target encoder of the retrieval augmented model by inputting the positive sample and the negative samples to the target encoder.

11. The method of claim 1, wherein
the values labeled on the negative samples are values greater than or equal to 0 and less than 1, and the value labeled on the positive sample is a value of 1.

12. A processor-implemented method with training of a retrieval augmented model, the method comprising:
generating a first embedding representation for a positive sample for a query and a second embedding representation for each of negative samples for the query output by a target encoder of the retrieval augmented model by inputting the positive sample and the negative samples to the target encoder, the positive sample and the negative samples being samples paired with the query;
labeling a value that is within a predetermined range of values and corresponds to a similarity between the first embedding representation for the positive sample and the second embedding representation for each of the negative samples, on a corresponding negative sample, wherein a maximum value of the predetermined range of values is labeled on the positive sample; and
training an online encoder of the retrieval augmented model based on a contrastive loss with respect to the query and the labeled positive sample and the labeled negative samples paired with the query.

13. The method of claim 12, wherein the training of the online encoder of the retrieval augmented model based on the contrastive loss comprises:
generating embedding representations output by the online encoder of the retrieval augmented model by inputting the query and the labeled positive sample and the labeled negative samples paired with the query to the online encoder;
determining the contrastive loss based on a similarity between a query embedding representation for the query and a sample embedding representation for each of the labeled positive sample and the labeled negative samples; and
training the online encoder based on the contrastive loss.

14. The method of claim 13, wherein the determining of the contrastive loss based on the similarity between the query embedding representation for the query and the sample embedding representation for each of the labeled positive sample and the labeled negative samples comprises determining the contrastive loss based on a first similarity between the query embedding representation for the query and a sample embedding representation for the labeled positive sample and a second similarity between the query embedding representation for the query and a sample embedding representation for each of the labeled negative samples.

15. The method of claim 13, further comprising training the target encoder of the retrieval augmented model by using an exponential moving average using a parameter of the trained online encoder.

16. The method of claim 15, further comprising:
generating a training dataset, using the trained target encoder, corresponding to a second batch that is different from the first batch comprising the query and the samples paired with the query among batches generated by sampling a raw dataset;
additionally training the trained online encoder based on the training dataset; and
additionally training the trained target encoder by using an exponential moving average using a parameter of the additionally trained online encoder.

17. The method of claim 12, further comprising:
obtaining one or more samples as a retrieval result for a user query from a database by using an trained retrieval augmented model comprising the trained online encoder; and
generating a response to the user query by using at least a portion of the one or more samples.

18. The method of claim 17, wherein the obtaining of the one or more samples as the retrieval result for the user query from the database by using the trained retrieval augmented model comprises:
generating an embedding representation output by the trained online encoder of the trained retrieval augmented model by inputting the user query to the trained online encoder; and
obtaining the one or more samples as the retrieval result from the database based on a comparison between the embedding representation for the user query and embedding vectors indexed on samples comprised in the database.

19. The method of claim 18, wherein the obtaining of the one or more samples as the retrieval result from the database based on the comparison between the embedding representation for the user query and the embedding vectors indexed on the samples comprised in the database comprises:
determining a score indicating a similarity between the embedding representation for the user query and the embedding representations indexed on the samples comprised in the database; and
obtaining, from the database, the one or more samples of which respective scores satisfy a determined condition among the samples comprised in the database as the retrieval result.

20. An electronic device comprising:
one or more processors comprising processing circuitry; and
memory comprising one or more storage media storing instructions that, when executed individually or collectively by the one or more processors, cause the electronic device to:
generate a first embedding representation for a positive sample for a query and a second embedding representation for each of negative samples for the query, the positive sample and the negative samples being samples paired with the query;
label a value that is within a predetermined range of values and corresponds to a similarity between the first embedding representation for the positive sample and the second embedding representation for each of the negative samples, on a corresponding negative sample, wherein a maximum value of the predetermined range of values is labeled on the positive sample; and
train a retrieval augmented model based on a contrastive loss with respect to the query and the labeled positive sample and the labeled negative samples paired with the query.
